(19) United States
(12) Patent Application Publication
(10) Pub. No.: US 2011/0288210 A1
(43) Pub. Date: Nov. 24, 2011

(54) Mesoporous Silicate Fire Retardant Compositions

(76) Inventors: Thomas J. Pinnavaia, East Lansing, MI (US); Joel I. Dulebohn, Lansing, MI (US); Bruce Nanasy, Noblesville, IN (US)

(21) Appl. No.: 13/110,239

(22) Filed: May 18, 2011

Related U.S. Application Data
(60) Provisional application No. 61/347,142, filed on May 21, 2010.
(60) Provisional application No. 61/356,141, filed on Jun. 18, 2010.

(51) Int. Cl. C08K 7/26; C08L 79/08; C08L 63/00; C08K 5/3492; F23G 5/50; C08K 3/22; C08K 3/26; C08K 3/34; C08K 3/40; C08L 23/12; C08K 3/32

(52) U.S. Cl. 524/100; 524/584; 524/606; 523/466; 524/416; 524/436; 524/424; 524/425; 524/451; 431/2

(57) ABSTRACT

Fire retardant or flame retardant additives are incorporated into thermoplastic, thermoset, and/or elastomeric polymer materials to form polymer compositions having improved fire retardant properties. More particularly, the polymer compositions of the present invention comprise additive compositions which have the effect of improving the FR effectiveness, the additive compositions comprising a mesoporous silicate additive. In addition, the polymer compositions of the present invention comprise additive compositions comprising a mesoporous silicate additive and a filler, wherein the filler is a flame retardant addition, an inert filler, or combinations thereof.

### STATEMENT REGARDING FEDERALLY SPONSORED RESEARCH

This invention was made with U.S. Government support awarded by the National Science Foundation Grant No. 0822808SBIR1. The United States has certain rights in this invention.

### FIELD OF THE INVENTION

This invention relates to fire retardant or flame retardant (these terms being synonymous for present purposes and abbreviated FR) additives for thermoplastic, thermoset, and/or elastomeric polymer materials. More particularly, the present invention relates to polymer compositions comprising fire retardant mesoporous silicate additives, which have the effect of synergistically improving the FR effectiveness of the polymer compositions. Moreover, the present invention relates to polymer compositions comprising fire retardant mesoporous silicate additives in combination with an additive, wherein the additive is a fire retardant filler, an inert filler or a combination thereof.

### BACKGROUND OF THE INVENTION

The combustion of most plastic polymers leads to the formation of a carbonaceous residue, ash or char. Many fire tests, such as the single burning item (SBI), UL94 and 3 m-cube test (IEC1034—also mentioned in other standards, for example BS 6724:1990 appendix F), have shown the importance of the physical properties of this char in controlling the flammability of plastics. Foamy char structure appears to be more fire resistant than brittle, thin char. Additives that increase the amount of char formation are known to be effective fire retardants. A publication (Fire-Retardant Additives for Polymeric Materials, Part I, Char Formation from Silica Gel-Potassium Carbonate, J W Gilman et al., Fire and Materials, 1997, 21(1):23-32) contains a review of char formation in various plastics and reports on the effect that silica gel and potassium carbonate additives have on polymer flammability.

Most plastics are flammable and require for many applications the incorporation of fire retardant agents to improve safety. (P Mourtiz, A G Gibson, “Fire Properties of Polymer Composites Materials,” Springer, 2007 ISSN 3925-0042). FR agents are especially important components of polymer composites used for electrical cable applications. When a plastic-coated electrical cable burns, the slumping or dripping of flaming polymer promotes the progression of the fire. The formation of a stable char layer after combustion of a section of the cable protects the underlying part of the cable structure as it creates a barrier to further combustion. Furthermore, the formation of a char layer is believed to be responsible for the reduction in the rate of heat release observed in the Cone calorimeter. Additives which have the effect of increasing the strength of the char formed when a plastic coated cable burns are therefore extremely valuable.

It has been previously reported that nano-clays, also known as organoclays, in combination with a second filler, improves the fire retardation capability of a broad range of plastics. However, the use of nano-clays imparts a number of limitations. Many of these limitations arise from the poor wetting properties of naturally occurring smectite clays when combined with a water-insoluble polymer or polymer precursor due to the incompatible surface polarity. To achieve exfoliation of the clay nanolayers in the polymer matrix, it is necessary to replace the inorganic exchange cations on the clay basal surface with alkylammonium or other organic cations. The organocations enlarge the gallery space between stacked nanolayers, lower the polarity of the surface and allow for the intercalation of polymer between nanolayers. Under appropriate, though often stringent processing conditions, complete exfoliation of the nanolayers into the polymer matrix can be achieved, however, such processing greatly increases the cost of the organoclay.

Another drawback of clay organic modification is the limited thermal stability of the organic modifier and the tendency of the modifier to function as a plasticizer that can compromise tensile properties. The thermal instability of the modifier places limits on the processing temperature for dispersing the clay particles in the polymer matrix. Modifiers that require a lower than normal processing temperature can lengthen the compounding time, thus causing a reduction in manufacturing efficiency. Even when thermal decomposition is avoided, the modifier can function as a plasticizer and reduce the glass transition temperature of the polymer.

With the use of polymeric materials still on the increase, there is a need for improved fire retardant additives, especially those that do not compromise the underlying properties of the base polymer and are non-toxic. In addition, there is a need for improved fire retardant additives, especially those that improve properties of the base polymer, such as strength and modulus properties.

### SUMMARY OF THE INVENTION

In one aspect of the invention, there is provided a polymer composition comprising a polymer and a flame retardant additive, the flame retardant additive comprising a mesoporous silicate wherein during combustion of the polymer composition a coherent char is formed.

In another aspect, the invention features a polymer composition comprising a polymer and a flame retardant additive combination comprising a mesoporous silicate and a second filler, wherein during combustion of the composition a coherent char is formed.

In another aspect, the invention features a method of improving the char promoting properties of a polymer composition, comprising: combining a polymer and a flame retardant additive, wherein the flame retardant additive comprises a mesoporous silicate, to thereby form a polymer compositing having improved char promoting properties.

In another aspect, the invention features a cable or wire coating formed from a polymer composition described herein. In another aspect the invention features a molded or extruded material coated with a polymer composition described herein.

In a further aspect, the invention features a method of promoting char formation comprising the step of burning the polymer composition described herein.

It is, therefore, an objective of the present invention to provide polymer compositions having improved fire retardant properties, comprising fire retardant additives that do not compromise the underlying properties of the base polymer and are non-toxic. In addition, it is an objective of the present invention to provide polymer compositions having improved fire retardant properties, including a mesoporous silicate additive, either alone or in combination with a second additive, for improving fire retardant properties and other properties of the base polymer, such as strength and modulus properties.

### BRIEF DESCRIPTION OF THE DRAWINGS

The above, as well as other advantages of the present disclosure, will become readily apparent to those skilled in the art from the following detailed description, particularly when considered in the light of the drawings described herein.

FIG. 1 shows Heat release curves for the pristine epoxy composite and corresponding composite containing 10 pph MSU-H mesoporous silicate.

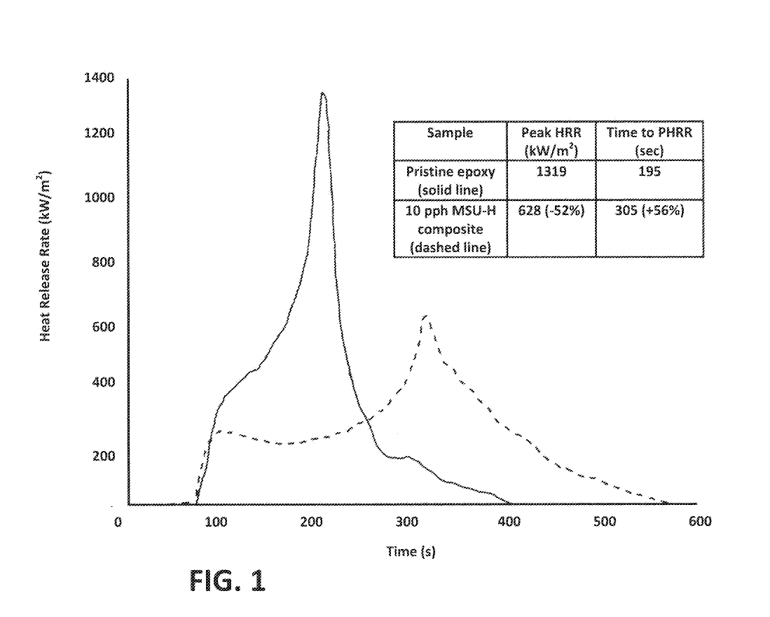

### DEFINITIONS

To facilitate an understanding of the present invention, a number of terms and phrases are defined below:

Nano-composites: A combination material made by mixing two or more phases such as particles, layers or fibers, where at least one of the phases is in the nanometer size range. Nano-clays and nano-composite clays are also known.

Coherent char: A char which holds together and would not fall off an underside surface when that surface is positioned substantially horizontally.

Silicate: A solid compound containing silicon covalently bonded to four oxygen centers to form tetrahedral SiO₄ subunits. One or more oxygen atoms of the subunit may bridge to one or more metal centers in the compound. Thus, one or more other elements may be combined with the element oxygen and the element silicon to form a silicate. The solid may be atomically ordered (crystalline) or disordered (amorphous). Silica in hydrated form (empirical formula SiO₂xH₂O, where x is a number denoting equivalent water content of the composition) or dehydrated form (empirical formula SiO₂) is included in the definition of this term. The compositions of silicates in which one or more other elements are combined with oxygen and silicon to form the compositions may be expressed in dehydrated mixed oxide form. For instance, the composition of a silicate containing aluminum in partial replacement of silicon in tetrahedral positions may be expressed as [SiO₂]₁₋ₓ[Al₂O₃]_{x/2}. A silicate containing aluminum and magnesium whether in tetrahedral or octahedral positions in the oxide may be written [SiO₂]_{1-x-y}[Al₂O₃]_{x/2}[MgO]_{y}. For the purposes of the present art, a silicate composition is one in which the ratio of silicon atoms to each of the remaining electropositive elements defining the composition is equal to or greater than one when the composition is written in dehydrated metal oxide form. For instance, the sodium exchange form of zeolite type A (also known as LTA zeolite) has the empirical dehydrated metal oxide composition [Na₂O]_{0.25}[SiO₂]_{0.50}[Al₂O₃]_{0.25}. Thus, for this silicate, the atomic ratios of Si/Na and Si/Al both are equal to one. That is, the atomic silicon content (Si) of the composition is at least as dominant as any other electropositive element used in describing the composition on a dehydrated metal oxide basis. As another example, the sodium exchange form of montmorillonite clay with the anhydrous metal oxide composition [Na2O]_{0.40}[Al₂O₃]_{1.6}[MgO]_{0.80}[SiO₂]_{8.0} meets the definition of a silicate because the atomic silicon content of the oxide substantially exceeds the cationic content of each of the other electropositive elements that describe the composition on an anhydrous metal oxide basis (i.e., Si/Na=10, Si/Al=2.5, SiMg=10).

Mesoporous silicate: A mesoporous silicate contains pores with an average diameter between about 2.0 and about 50 nm. A mesoporous solid may also contain micropores with an average diameter less than 2.0 nm, as well as macropores with an average diameter greater than 50 nm. For the purposes of this invention, a solid is a useful mesoporous solid if at least 20% of the total pore volume is due to the presence of pores with an average diameter between 2.0 and 50 nm. More specifically, the mesopore volume of a mesoporous silicate is at least 0.10 cm³/gram. There are two possible types of mesopores, namely intraparticle mesopores wherein the mesopores are contained within fundamental particles and connect to the external surfaces of the particle and interparticle mesopores wherein the mesopores are formed through the aggregation of fundamental particles. A mesoporous silicate may contain both types of mesopores. Surfactant template MCM-41 silica is an example of a mesoporous silicate containing largely intraparticle mesopores. Mesoporous SZSM-5 zeolite is an example of a mesoporous silicate that can contain both inter- and intra-particle mesopores. The pore walls of a mesoporous silicate may be crystalline (atomically ordered) or amorphous (lacking in atomic order). Further the pore network of a mesoporous silicate may be mesostructured and exhibit a pore-to-pore correlation length of 2.0 nm or more, though this is not an essential physical feature of a mesoporous silicate.

Total pore volume: This quantity is defined here as the volume of nitrogen adsorbed by a porous silicate at the boiling point of nitrogen and a partial pressure of 0.98 after the solid has been out-gassed by heating in a vacuum at a temperature of at least 150° C. for a period of at least four hours.

Mesopore volume: For a porous silicate substantially lacking in micropores, the mesopore volume is equal to the total pore volume. For a porous silicate containing micropores, the mesopore volume is taken as the difference between the total pore volume and the volume of nitrogen filling the micropores at a partial pressure of approximately 0.15.

Mesostructured: This term refers to a structured form of a solid wherein the element of repeating element of structure of a pore-to-pore correlation length on a length scale between 2-50 nm, which results in the presence of at least one Bragg reflection in the small angle X-ray powder diffraction pattern of the solid. The repeating element of structure may be atomically ordered (crystalline) or disordered (amorphous). In the case of ordered mesoporous (mesostructured) solids, the pores and pore walls represent the element of structure that gives rise to Bragg reflections in the small angle X-ray diffraction pattern of the solid. Mesostructured silicates typically are prepared in the presence of surfactant micelles that act as structure-directing pore templates. The surfactant porogen is subsequently removed by solvent extraction removal or by calcination to provide an open pore structure.

Heat Release Rate (HRR): The rate of energy release from a burning material normalized by the size of the burning material, measured in units of power per area, such as KW/m².

Peak Heat Release Rate (PHRR): The maximum energy release rate from a burning material.

Time to Peak Heat Release Rate: The length of time from the initial application of heat to a material to the occurrence of the peak heat release rate of the material during combustion of the material.

### DETAILED DESCRIPTION OF THE PRESENTLY PREFERRED EMBODIMENTS

The following description is merely exemplary in nature and is not intended to limit the present disclosure, application, or uses. It should also be understood that throughout the reference numerals indicate like or corresponding parts and features. In respect of the methods disclosed, the order of the steps presented is exemplary in nature, and thus, is not necessary or critical, unless otherwise noted. In addition, while much of the present invention is illustrated using specific examples, the present invention is not limited to these embodiments. All publications, patent applications, patents, and other references mentioned herein are incorporated by reference in their entireties. In case of conflict, the present specification, including definitions, will control.

According to this invention, there is provided a polymer composition comprising a polymer and a mesoporous silicate and, optionally, one or more additional synergistic FR additives, one or more fillers, or combinations thereof wherein during combustion of the composition a coherent char is formed. Alternatively, or in addition, according to the present invention, there is provided a polymer composition comprising a polymer and a mesoporous silicate and, optionally, one or more additional synergistic FR additives, one or more fillers, or combinations thereof, wherein the polymer composition has improved fire retardant properties when compared to polymer compositions without the mesoporous silicate. Specifically, the present invention provides polymer compositions with at least one mesoporous silicate additive, and optionally other additives, having lower peak heat release rates and/or longer times to peak heat release rate compared to polymer compositions without the mesoporous silicate additive.

The presence of a second additive, such as either a second flame retardant additive, an inert filler, or combinations thereof, may increase the strength of the char formed during combustion. The formation of a strong char creates a thermal barrier to combustion of the underlying material. The compositions of this invention are flame retardant at least in part because an effective char is formed. Moreover, the presence of a second additive, such as a second flame retardant additive, an inert filler, or combinations thereof, in combination with a mesoporous silicate additive, lowers the peak heat release rates and times to peak heat release rate of the polymer compositions when compared to polymers without mesoporous silicate additives.

The fire retardant additives which characterize this invention are suitable for inclusion in a wide range of polymers, including thermoplastic polymers, thermoset polymers, elastomeric polymers, and combinations thereof.

Examples of suitable thermoplastic polymers include acrylonitrile-butadiene-styrene, cellulosic polymers, ethylene vinyl alcohol, liquid crystal polymer, phenolics, polyacetal, polyacrylates, polyacrylanitrile, polyamide, polyamide-imide, polyarylene ether, polyarylene ether-polyamide blends, polyaryletherketone, polybutadiene, polybutylene, polycarbonate, polychloroprene, polyester and unsaturated polyester, polyetheretherketone, polyetherimide, polyethylene, polyimide, polyphenylene oxide, polyphthalamide, polypropylene, polypropylene and polyethylene copolymers, polystyrene, polyurethane, polyvinylchloride (PVC), polyvinylidene chloride, thermoplastic elastomers and combinations of polymers. The fire retardant additive combinations which characterize this invention are suitable for inclusion in a wide range of thermoset polymers. A particularly preferred use of the compositions of this invention is in cables for electrical or optical transmission. Flexible PVC has been a material of choice for cable sheathing for many years in part because of its low cost and good electrical insulating properties. The compositions may, for example, also be used to coat other molded or extruded materials. The coating may be, for example, a sheath, jacket or insulation.

The fire retardant additive combinations which characterize this invention are suitable for inclusion in a wide range of thermoset polymers. Examples include allyl resin, epoxy, melamine formaldehyde, phenol-formaldehyde plastic, polyester, polyimide, polyurethane, silicone and silicone rubber. A particularly preferred use of the compositions of this invention is as epoxy circuit boards and as structural components for electric motors. The thermoset compositions may, for example, also be used as coatings and potting materials. The coating may be, for example, a paint or sealant.

Examples of elastomeric polymers include ethylene vinyl acetate (see, for example, the uses of EVA at http:en.wikipedia.org/wiki/ethylene-vinyl_acetate). Styrenic block copolymers, polyolefin blends, elastomeric alloys (e.g., the thermoplastic vulcanates TPE-v or TPV), thermoplastic polyurethanes, thermoplastic copolyester and thermoplastic polyamides are general classes of elastomeric polymers.

The mesoporous silicates which characterize this invention are preferably surfactant-templated mesostructure silicates with intraparticle mesopores and mesoporous zeolitic silicates with interparticle mesopores. These materials exhibit pore volumes primarily in the mesopore size range and are particularly preferred.

The optional second additives or fillers which characterize this invention are one or more known flame retardants, one or more inert fillers, or some combination thereof.

The optional second additives or fillers are selected from the group consisting of aluminum hydroxide (also in the form of aluminum trihydrate (ATH), aluminum trihydroxide and in the mineral gibbsite or the ore bauxite), magnesium carbonate, magnesium oxide, magnesium hydroxide (which could be added as either the refined compound of the mineral brucite), hydromagnesite, hunite [Mg₃Ca(CO₃)₄], hydrotalcite and like mixed magnesium-aluminum hydroxides with layered lattice structures, boehnite, bentonite, montmorillonite, hectorite, and halloysite nano-clays, phosphates (e.g., zinc phosphates), borates (e.g., zinc borates), stannates and hydroxystannates (e.g., zinc stannates and hydrostannates), zinc oxide, zinc sulfides and molybdates (e.g., ammonium molybdates), particularly in combination with magnesium or aluminum hydroxides and the mesoporous silicate. The optional second filler additionally may be selected from the group consisting of FR agents that function as intumescent FR agents (e.g., ammonium polyphosphates, melamine, melamine phosphates), materials that act as diluents or the combustible gases (e.g., potassium carbonate), or smoke suppressants (e.g., magnesium hydroxide). Other suitable second fillers include FR agents selected from the group consisting of organophosphates, antimony oxide, red phosphorous, and brominated hydrocarbons, though these are less preferred due to toxicity or environmental concerns. It is to be understood that these substances may be added to the mesoporous containing composition either individually or in combinations of two or more. The optional second FR agent preferably is added to the mesoporous silicate in the form of a separate solid phase. However, those skilled in the art of supported catalysts and supported reagents will recognize that in the case of soluble FR agents such as urea, melamine, potassium carbonate, organophosphates, and brominated hydrocarbons, the second filler may be dispersed in the pores of the mesoporous silicate by incipient wetness methods (J. Haber, J. H. Block, B. Delmon, “Manual of methods and procedures for catalyst characterization,” Pure and Applied Chemistry, 1995 67 (8/9), 1257-1306). The dispersion of the second FR agent in the pores of the mesoporous silicate by incipient wetness methods may enhance the synergistic char-forming benefit of the composition in comparison to the same composition consisting of mixtures of separate solid phases.

An inert filler is one that does not have a flame retardant effect when used alone in a polymer, but it functions as a diluent and reduces the amount of heat released upon combustion in proportion to the amount of filler contained in the composite. A number of inert fillers are known in the art and are commonly used as polymer additives. Such substances include chalk, talc, and glass powder. It is to be understood that these fillers may be added to the mesoporous containing composition either individual or in combinations of two or more.

Other known inert fillers or flame retardant fillers could be used instead of, or in addition to, those listed above and still produce a synergistic effect.

The aggregated particle size of the second filler is preferably less than 10 μm, more preferably less than 5 μm, most preferably less than 1 μm. The second filler may have a surface area which is greater than 1 m²/g, preferably not greater than 150 m²/g.

When the second filler is optionally employed, the proportion of the mesoporous silicate component to the other filler component in the compositions of this invention is typically from about 90%/10% to about 10%/90% by weight. The proportion of mesoporous silicate may preferably be between about 1 and about 80% by weight of the total filler content. The total filler content (i.e. mesoporous silicate plus the one or more other filler) may be from about 1.0% to about 80%, preferably from about 10% to about 70% by weight. The compositions may also include further constituents which are routinely present in conventional fire retardant products, such as stabilizers.

The compositions of this invention result from the finding that adding a mesoporous silicate and optionally a second FR agent to plastics surprisingly and significantly increases the amount of char and the strength of the char that forms during combustion. Moreover, the compositions of the present invention, including mesoporous silicates and, optionally, second additives or fillers, lower the peak heat release rates and the times to peak heat release rates compared to polymers without the mesoporous silicates and, optionally, the second additives or fillers. While not bound by theory, mesoporous silicates are believed to function as anti-dripping agents during the combustion of the polymer. The increased viscosity of the molten polymer is thought to reduce the spread of the flame. The increased viscosity may reduce convention forces and this may promote thicker and strong char formation, though other char-forming mechanisms also may apply. It is possible that the second FR agent or other filler aids mixing of the mesoporous silicate and the polymer, or there may be some chemical or physical effect that occurs during burning. Alternatively, the fillers may mechanically reinforce the char, or the filler may act as a support for the mesoporous silicate.

According to a further aspect of the present invention, there is provided a method of improving the char promoting properties of a polymer composition, which method comprises the steps of combining a polymer and a synergistic flame retardant additive combination which comprises a mesoporous silicate and optionally a second filler.

The FR benefits of mesoporous silicate are illustrated in the examples provided below. Seven compositional and structural forms of mesoporous silicates are used in illustrating the FR of this invention. Three forms of mesoporous silica, denoted MSU-F, LMS and MSU-H, with anhydrous formulas of SiO₂, were prepared according to previously reported methods using a mixture of polyethylene oxide-polypropylene oxide-polyethylene oxide and mesitylene as the mesoporogen, a Gemini surfactant porogen, and a single polyethylene oxide-polypropylene oxide-polyethylene oxide surfactant as the porogen, respectively. A mesoporous aluminosilicate with the anhydrous formula (SiO₂)_{0.97}(Al₂O₃)_{0.015}, denoted 3% Al-MSU-H, was prepared according to previously described methods. A mesoporous form of a crystalline silicate clay (saponite), denoted SAP was prepared according to the general methods describe by R. J. M. J. Vogels, M. J. H. V. Kerkhoffs, J. W. Geus, Stud. Surf. Sci. Catal. 91 (1995) 1153, using water glass (27 wt. % silica, 14 wt. % NaOH), Al(NO₃)₃(H₂O)₉, Mg(NO₃)₂(H₂O)₆ as the sources of silicon, aluminum and magnesium. The surface areas (S Brunauer, P H Emmett and E Teller, J. Am. Chem. Soc., 1938, 60, 309), total pore volumes, mesopore volumes, and average BJH pore volumes (E P Barret, L G Joyner, P H Halenda, J. Am. Chem. Soc. 73 (1951) 373) for each mesoporous silicate are provided in the following Table 1:

TABLE 1

| | Surface | Average | | |
|---|---|---|---|---|
| | area | pore | Mesopore | Total Pore |
| | (m2/g) | size (nm) | volume (cm3/g) | volume (cm3/g) |
| MSU-F | 520 | 22.8 | 2.0 | 2.2 |
| MSU-H | 771 | 8.7 | 0.9 | 1.2 |
| 3% | 650 | 8.5 | 0.8 | 1.0 |
| Al-MSU-H | | | | |
| LMS | 330 | 3.5 | 0.8 | 0.8 |
| SAP90 | 447 | — | 0.8 | 0.8 |
| HSAP | 553 | — | 1.43 | 1.43 |
| MSU-G | 640 | 2.0 | 0.55 | 0.55 |

In the above Table 1, mesopore volume is defined to be the sum of framework pore volume and textural pore volume, as MSU-H and MSU-F material have micropores in the framework. HSAP is the protonated form of SAP90 made by ammonium exchange of SAP90 and subsequent calcination of the ammonium exchange form at 550° C.

References to the previously described synthesis methods used to prepare the mesoporous silicates in the above table are as follows:

MSU-F reference: Kim, Seong-Su; Paul, Thomas R.; Pinnavaia, Thomas, J. “Non0ionic surfactant assembly of ordered, very large pore molecular sieve silicas from water soluble silicates” Chemical Communications 2000, 17, 1661-1662.

MSU-H reference: a) Kim, Seong-Su; Karkamkar, Abhijeet; Pinnavaia, Thomas J.; Kruk, Michal; Jaroniec, Mietek, “Synthesis and characterization of ordered, very large pore MSU-H silicas assembled from water-soluble silicates” J Phys. Chem. B 2001, 105, 7663-7670; and b) MSU-H references: Zhao, Dongyuan; Huo, Qisheng; Feng, Jianglin; Chmelka, Bradley F.; Stucky, Galen D. “Nonionic Triblock and Star Diblock Copolymer and Oligomeric Surfactant Synthesis of Highly ordered, Hydrothermally Stable, Mesoporous Silica Structures” J. Am. Chem. Soc., 1998, 120, 6024; Kim, Seong-Su; Paul, Thomas R.; Pinnavaia, Thomas J. Non-ionic surfactant assembly of ordered, very large pore molecular sieve silicas from water soluble silicates. Chemical Communications (Cambridge) (2000), (17), 1661-1662.

3% Al-MSU-H reference: Liu, Yu; Kim, Seong Su; Pinnavaia, Thomas J. Mesostructured aluminosilicate alkylation catalysts for the production of aromatic amine antioxidants. Journal of Catalysis (2004), 225(2), 381-287.

LMS reference: Park I: Kim Seong-Su; Pinnavaia, Thomas J. “Lamellar silica mesostructures assembled from a new class of Gemini surfactants; alkyloxypropyl-1,3-diaminonpropanes” Journal Porous Material 2010, 17, 133-138.

SAP 90 reference: Vogel, R. J. M. J.; Kerkhoffs, M. J. H. V.; Geus, J. W. “Non-Hydrothermal Synthesis, Characterisation and Catalytic Properties of Saponite Clays” Stud. Surf. Sci. Catal. 1995, 91, 1153.

MSU-G reference: Kim, Seong Su; Zhang, Wenzhong; Pinnavaia, Thomas J. “Ultrastable mesostructured silica vesicles”. Science 1998, 282, 1302-1305.

Three different polymer matrices illustrate the FR benefits provided by the mesoporous silicates of this invention when the particles are dispersed as a single phase in the polymer or, optionally, in combination with one or more FR synergists. The polymers selected are a thermoset epoxy (examples 1-6), a thermoplastic polypropylene (examples 7-8), and a polyimide (example 9).

### Example 1

### Epoxy-Mesoporous Silicate Composites

Cone calorimeter plaques were prepared as follows: a 76-gram quantity of epoxy polymer (Epon 826) was weighed into a plastic beaker. The beaker was placed in a 50° C. sand bath for 20 minutes. At the end of the 20 minutes, 5.0 or 10.0 grams of the desired mesoporous silicate additive was added and stirred—in by hand for 20 minutes. After stirring was completed, the composited polymer mixture was allowed to age in the 50° C. sand bath for one hour. The beaker containing the mixture was removed from the sand bath. Next, 24 grams of curing agent (Jeffamine D-230) were added and incorporated by hand stifling. Once incorporated, the mixture was stirred magnetically for 20 minutes. The mixture was then de-gassed under vacuum. Once de-gassed under vacuum at 50° C., the mixture was placed in silicone molds measuring 100 mm×100 mm×5 mm. The molds were pre-cleaned with ethyl alcohol and pre-treated with release agent (Mono-Coat E179). The specimens were then cured for three hours at 75° C. and an additional three hours at 125° C. Upon completion of the cure cycle, the specimens were removed from the mold in order to determine the peak heat release rate (PHRR) and the time to reach the PHRR (sec), cone calorimeter testing was done at a heat flux of 50 kW/m² using a standard FTT Cone calorimeter (Fire Testing Technology, Ltd.).

The PHRR (kW/m²) values and time to reach the HRR (sec), respectively, are provided below for (a) the pristine epoxy in the absence of a mesoporous silicate FR agent and for (b)-(e) composites of the epoxy containing 5 parts per hundred (pph) of a representative mesoporous FR agent. The values in parenthesis report the percent change in PHRR and the time to PHRR in comparison to the pristine polymer.
(a) Pristine epoxy: 1319 KW/m² and 190 sec;
(b) 100 grams epoxy+5 grams of LMS: 891 KW/m² (−32%) and 285 sec (+50%);
(c) 100 grams epoxy+5 grams of MSU-H: 948 KW/m² (−28%) and 225 sec (+18%);
(d) 100 grams epoxy+5 grams of MSU-G: 939 KW/m² (−29%) and 220 sec (+16%);
(e) 100 grams epoxy+5 grams of 3% Al-MSU-H: 815 KW/m² (−38%) and 225 sec (+18%);
(f) 100 grams epoxy+5 grams of SAP90: 1054 KW/m² (−20%) and 235 sec (+24%)
(g) 100 grams epoxy+10 grams of MSU-H: 628 KW/m² (−52%) and 305 sec (+56%).

The relative mechanical properties are further listed below for samples (a), (e) and (g), including tensile strength and tensile modulus (MPa). The values in parenthesis report the percent change in tensile strength and tensile modulus in comparison to the pristine polymer.
(a) Tensile strength 66, tensile modulus 2671;
(e) Tensile strength 69 (+5%), tensile modulus 3240 (+21%);
(g) Tensile strength 73 (+11%), tensile modulus 3334 (+25%).

The polymer compositions in Example 1 utilizing mesoporous silicate particles as additives exhibit substantial improvements in PHRR and time to PHRR in comparison to the pristine polymer specimen. This improvement in FR properties is due to the formation of high integrity char by the mesoporous particles. Moreover, the polymer compositions in Example 1 showed improved mechanical properties for samples having flame retardant mesoporous silicate additives in comparison to the pristine polymer.

### Example 2

### Epoxy-Mesoporous Silicate-Urea Composites

Cone calorimeter plaques were prepared as follows: a 76-gram quantity of epoxy polymer (Epon 826) was weighed into a plastic beaker. The beaker was placed in a 50° C. sand bath for 20 minutes. At the end of the 20 minutes, mesoporous silicate and urea additives were added and stirred-in by hand for 20 minutes. After stifling was completed, the composite polymer mixture was allowed to age in the 50° C. sand bath for one hour. The beaker containing the mixture was removed from the sand bath. Next, 24 grams of curing agent (Jeffamine D-230) were added and incorporated by hand stifling. Once incorporated, the mixture was stirred magnetically for 20 minutes. The mixture was then de-gassed under vacuum. Once de-gassed under vacuum at 50° C., the mixture was placed in silicone molds measuring 100 mm×100 mm×5 mm. The molds were pre-cleaned with ethyl alcohol and pre-treated with release agent (Mono-Coat E179). The specimens were then cured for three hours at 75° C. and an additional three hours at 125° C. Upon completion of the cure cycle, the specimens were removed from the mold in order to determine the peak heat release rate (PHRR) and the time to reach the PHRR (sec), cone calorimeter testing was done at a heat flux of 50 kW/m² using a standard FTT Cone calorimeter (Fire Testing Technology, Ltd.).

The PHRR (KW/m²) values and time to reach the PHRR (sec), respectively, are provided below for (a) the pristine epoxy in the absence of a mesoporous silicate FR agent, (b) a composite containing only 10 pph urea and (c) and (d) composites containing 10 pph urea and 5 pph of mesoporous silicate. The values in parenthesis report the percent change in the PHRR and the time to PHRR in comparison to the corresponding values for the pristine polymer.
(a) Pristine epoxy: 1310 KW/m² and 190 sec;
(b) 100 grams epoxy+10 grams urea: 896 KW/m² (−32%) and 255 sec (+34%);
(c) 100 grams epoxy+10 grams urea+5 grams LMS: 737 KW/m² (−44%) and 305 sec (+61%);
(d) 100 grams epoxy+10 grams urea+5 grams MSU-H: 766 KW/m² (−42%) and 260 sec (+37%).

### Example 3

### Epoxy-Mesoporous Silicate-Ammonium Polyphosphate Composites

Cone calorimeter plaques were prepared as follows: a 76-gram quantity of epoxy polymer (Epon 826) was weighed into a plastic beaker. The beaker was placed in a 50° C. sand bath for 20 minutes. At the end of the 20 minutes, mesoporous silicate and Exolit 422 ammonium polyphosphate (Clariant) additives were added and stirred—in by hand for 20 minutes. After stirring was completed, the composited polymer mixture was allowed to age in the 50° C. sand bath for one hour. The beaker containing the mixture was removed from the sand bath. Next, 24 grams of curing agent (Jeffamine D-230) were added and incorporated by hand stirring. Once incorporated, the mixture was stirred magnetically for 20 minutes. The mixture was then de-gassed under vacuum. Once de-gassed under vacuum at 50° C., the mixture was placed in silicone molds measuring 100 mm×100 mm×5 mm. The molds were pre-cleaned with ethyl alcohol and pre-treated with release agent (Mono-Coat E179). The specimens were then cured for three hours at 75° C. and an additional three hours at 125° C. Upon completion of the cure cycle, the specimens were removed from the mold in order to determine the peak heat release rate (PHRR) and the time to reach the PHRR (sec), cone calorimeter testing was done at a heat flux of 50 kW/m² using a standard FTT Cone calorimeter (Fire Testing Technology, Ltd.).

The PHRR (KW/m²) values and time to reach the PHRR (sec), respectively, are provided below for (a) the pristine epoxy in the absence of a mesoporous silicate FR agent, (b) the epoxy containing 5 parts per hundred (pph) of Exolit 422 ammonium polyphosphate, and (c) the epoxy containing 5 pph of Exolit 422 and 5 pph of mesoporous MLS silicate. The values in parenthesis report the percent change in the PHRR and the time to PHRR in comparison to the pristine polymer.
(a) Pristine epoxy: 1319 KW/m² and 190 sec;
(b) 100 grams epoxy+5 grams Exolit 422 composite: 1206 KW/m² (−9%) and 120 sec (−37%;
(c) 100 grams epoxy+5 grams Exolit 422+5 grams LMS: 839 KW/m² (−36%) and 245 sec (+29%).

### Example 4

### Epoxy-Mesoporous Silicate-Melamine-Magnesium Hydroxide Composites

Cone calorimeter plaques were prepared as follows: a 76-gram quantity of epoxy polymer (Epon 826) was weighed into a plastic beaker. The beaker was placed in a 50° C. sand bath for 20 minutes. At the end of the 20 minutes, mesoporous silicate and melamine and magnesium hydroxide additives were added and stirred—in by hand for 20 minutes. After stifling was completed, the composited polymer mixture was allowed to age in the 50° C. sand bath for one hour. The beaker containing the mixture was removed from the sand bath. Next, 24 grams of curing agent (Jeffamine D-230) were added and incorporated by hand stirring. Once incorporated, the mixture was stirred magnetically for 20 minutes. The mixture was then de-gassed under vacuum. Once de-gassed under vacuum at 50° C., the mixture was placed in silicone molds measuring 100 mm×100 mm×5 mm. The molds were pre-cleaned with ethyl alcohol and pre-treated with release agent (Mono-Coat E179). The specimens were then cured for three hours at 75° C. and an additional three hours at 125° C. Upon completion of the cure cycle, the specimens were removed from the mold in order to determine the peak heat release rate (PHRR) and the time to reach the PHRR (sec), cone calorimeter testing was done at a heat flux of 50 kW/m² using a standard FTT Cone calorimeter (Fire Testing Technology, Ltd.).

The PHRR (KW/m²) values and time to reach the PHRR (sec), respectively, are provided below for (a) the pristine epoxy in the absence of a mesoporous silicate FR agent, (b) the epoxy containing 10 parts per hundred (pph) of melamine and 5 pph of magnesium hydroxide, magnesium oxide, and (c) and (d) the epoxy containing 10 pph of melamine, 5 pph of magnesium hydroxide, magnesium oxide, and 5 pph of mesoporous silicate. The values in parenthesis report the percent change in the PHRR and the time to PHRR in comparison to the pristine polymer.
(a) Pristine epoxy: 1319 KW/m² and 190 sec;
(b) 100 grams epoxy+10 grams melamine+5 grams of Mg(OH)₂: 595 KW/m² (−55%) and 210 sec (+11%);
(c) 100 grams epoxy+10 grams melamine+5 grams of Mg(OH)₂+5% MSU-H: 518 KW/m² (−61%) and 240 sec (+26%);
(d) 100 grams epoxy+10 grams melamine+5 grams of Mg(OH)₂+5% SAP90: 505 KW/m² (−62%) and 300 sec (+58%).

### Example 5

### Epoxy-Mesoporous Silicate-Melamine-Ammonium Polyphospate Composites

Cone calorimeter plaques were prepared as follows: a 76-gram quantity of epoxy polymer (Epon 826) was weighed into a plastic beaker. The beaker was placed in a 50° C. sand bath for 20 minutes. At the end of the 20 minutes, mesoporous silicate, melamine and Exolit 422 ammonium polyphosphate additives were added and stirred—in by hand for 20 minutes. After stirring was completed, the composited polymer mixture was allowed to age in the 50° C. sand bath for one hour. The beaker containing the mixture was removed from the sand bath. Next, 24 grams of curing agent (Jeffamine D-230) were added and incorporated by hand stirring. Once incorporated, the mixture was stirred magnetically for 20 minutes. The mixture was then de-gassed under vacuum. Once de-gassed under vacuum at 50° C., the mixture was placed in silicone molds measuring 100 mm×100 mm×5 mm. The molds were pre-cleaned with ethyl alcohol and pre-treated with release agent (Mono-Coat E179). The specimens were then cured for three hours at 75° C. and an additional three hours at 125° C. Upon completion of the cure cycle, the specimens were removed from the mold in order to determine the peak heat release rate (PHRR) and the time to reach the PHRR (sec), cone calorimeter testing was done at a heat flux of 50 kW/m² using a standard FTT Cone calorimeter (Fire Testing Technology, Ltd.).

The PHRR (KW/m²) values and time to reach the PHRR (sec), respectively, are provided below for (a) the pristine epoxy in the absence of a mesoporous silicate FR agent, (b) the epoxy containing 10 pph of melamine, 10 pph Exolit 442 ammonium polyphosphate and 5 pph of mesoporous silicate. The values in parenthesis report the percent change in the PHRR and the time to PHRR in comparison to the pristine polymer.
(a) Pristine epoxy: 1319 KW/m² and 190 sec;
(b) 100 grams epoxy+10 grams melamine+10 grams Exolit 422+5 grams MSU-H: 581 KW/m² (−56%) and 190 sec (+0%).

### Example 6

### Epoxy-Mesoporous Silicate-Melamine-Magnesium Hydroxide-Ammonium Polyphosphate Composites

Cone calorimeter plaques were prepared as follows: a 76-gram quantity of epoxy polymer (Epon 826) was weighed into a plastic beaker. The beaker was placed in a 50° C. sand bath for 20 minutes. At the end of the 20 minutes, mesoporous silicate and melamine, magnesium hydroxide, and Exolit 422 ammonium polyphosphate additives were added and stirred—in by hand for 20 minutes. After stirring was completed, the composited polymer mixture was allowed to age in the 50° C. sand bath for one hour. The beaker containing the mixture was removed from the sand bath. Next, 24 grams of curing agent (Jeffamine D-230) were added and incorporated by hand stirring. Once incorporated, the mixture was stirred magnetically for 20 minutes. The mixture was then de-gassed under vacuum. Once de-gassed under vacuum at 50° C., the mixture was placed in silicone molds measuring 100 mm×100 mm×5 mm. The molds were pre-cleaned with ethyl alcohol and pre-treated with release agent (Mono-Coat E179). The specimens were then cured for three hours at 75° C. and an additional three hours at 125° C. Upon completion of the cure cycle, the specimens were removed from the mold in order to determine the peak heat release rate (PHRR) and the time to reach the PHRR (sec), cone calorimeter testing was done at a heat flux of 50 kW/m² using a standard FTT Cone calorimeter (Fire Testing Technology, Ltd.).

The PHRR (KW/m²) values and time to reach the PHRR (sec), respectively, are provided below for (a) the pristine epoxy in the absence of a mesoporous silicate FR agent, (b) the epoxy containing 10 parts per hundred (pph) of melamine, 5 pph of magnesium hydroxide, and 5 pph of Exolit 422 and (c) and (d) the epoxy containing 10 pph of melamine, 5 pph of magnesium hydroxide, 5 pph of Exolit 422 and 5 pph of mesoporous silicate. The values in parenthesis report the percent change in the PHRR and the time to PHRR in comparison to the pristine polymer.
(a) Pristine epoxy: 1319 KW/m² and 190 sec;
(b) 100 grams epoxy+10 grams melamine+5 grams of Mg(OH)₂: +5 grams Exolit 422: 780 KW/m² (−41%) and 205 sec (+8%);
(c) 100 grams epoxy+10 grams melamine+5 grams of Mg(OH)₂+5 grams Exolit 422+5 grams LMS: 560 KW/m² (−58%) and 260 sec (+37%);
(d) 100 grams epoxy+10 grams melamine+5 grams of Mg(OH)₂+5 grams Exolit 422+5 grams MSU-H: 503 KW/m² (−62%) and 300 sec (+58%).

### Example 7

### Polypropylene-Mesoporous Silicate Composites

Polypropylene composite strands containing 15 wt % of representative mesoporous silicates were blended and extruded in a 15-cc DSM bench top mini-extruded operated at top, center and bottom temperatures of 200° C. The screw speed for fill, process and end was 100 rpm and the contact time was 2 minutes. The strands were then chopped and press-molded into plaques using a Carver Press Model 2518 with platens heated to 250° C. and the press time was 6 minutes at 35,000 pounds. The mold measured 100 mm×100 mm×3 mm.

The PHRR (KW/m²) and time to reach PHRR (sec), respectively, are provided below for (a) the pristine polypropylene polymer in the absence of a mesoporous silicate FR agent and for (b)-(e) composites of the polypropylene containing 15 wt % of mesoporous silicate FR agents. The values in parenthesis report the percent change in the PHRR and the time to PHRR in comparison to the pristine polymer.
(a) Pristine PP: 1608 KW/m² and 145 sec;
(b) 85 wt % PP+15 wt % SAP: 788 KW/m² (−51%) and 217 sec (+50%);
(c) 85 wt % PP+15 wt % MSU-F: 643 KW/m² (−60%) and 228 sec (+57%);
(d) 85 wt % PP+15 wt % protonated SAP (HSAP): 968 KW/m² (−40%) and 177 sec (+22%);
(e) 85 wt % PP+7.5 wt % MSU-F+7.5% HSAP: 780 KW/m² (−51%) and 201 sec (+28%).

The relative mechanical properties are further listed below for samples (a)-(d), including tensile strength, tensile modulus, flexure strength and flexure modulus (MPa). The values in parenthesis report the percent change in tensile strength, tensile modulus, flexure strength and flexure modulus in comparison to the pristine polymer.
(a) Tensile strength 16.4, tensile modulus 755, flexure strength 20.3 and flexure modulus 825;
(b) Tensile strength 17.5 (+6.7%), tensile modulus 1065 (+41%), flexure strength 28.7 (+41%) and flexure modulus 1232 (+49%);
(c) Tensile strength 16.8 (−1.8%), tensile modulus 801 (+1.5%), flexure strength 231 (+22%) and flexure modulus 1003 (+36%);
(d) Tensile strength 17.6 (+7.3%), tensile modulus 1191 (+58%), flexure strength 28.7 (+41%) and flexure modulus 1233 (+49%).

The polymer compositions in Example 7 utilizing mesoporous silicate particles as additives exhibit substantial improvements in PHRR and time to PHRR in comparison to the pristine polymer specimen. This improvement in FR properties is due to the formation of high integrity char by the mesoporous particles. Moreover, the polymer compositions in Example 7 showed improved mechanical properties for samples having flame retardant mesoporous silicate additives in comparison to the pristine polymer.

### Example 8

### Polypropylene-Mesoporous Silicate-Potassium Carbonate Composites

Polypropylene composite strands containing representative mesoporous silicates and potassium carbonate were blended in a 15-cc DSM bench top mini-extruder operated at top, center and bottom temperatures of 200° C. The screw speed for fill, process and end was 100 rpm and the contact time was 2 minutes. The composites were transferred to a 3.6 cc injection chamber then injected in to a mold with dimension of 62 mm×12 mm×3 mm with a pressure of 90 psi. The mold hold time was 15 seconds. The specimens were placed in a horizontal position and a Bunsen burner flame was applied at the front edge of the polymer. The Bunsen burner was removed when the flame was established and the amount of coherent char formed in the combustion was weighed. The results are presented in the following Table 2:

TABLE 2

| | Wt. of sample | Wt. of coherent | Wt. % |
|---|---|---|---|
| Sample | (g) | char (g) | char |
| Polypropylene | 3.300 | 0 | 0 |
| 90 wt % PP + 6 wt % | 2.985 | 0.735 | 24.6 |
| MSU-H + 4 wt % K₂CO₃ | | | |
| 94 wt % PP + 6 wt % MSU-H | 2.864 | 0.248 | 8.7 |

### Example 9

### Polyimide-Mesoporous Silicate Composite Films

This example illustrates the FR benefits provided by mesoporous silicates as an additive in a polymer film. To demonstrate a representative preparation of a mesoporous silicate-polyimide composite film, a mixture of 0.27 g of inorganic fillers and 10.53 g of DMAc (dimethylacetamide) was stirred vigorously for 3 hours at 25° C., yielding a 2.5 wt % DMAc dispersion of inorganic particulates. A 1.29 g quantity of 4,4′-diaminodiphenyl ether was dissolved in 35.88 g of DMAc by stirring for 30 min, followed by adding 1.41 g of pyrometallic dianhydride. This mixture was stirred in a dry, sealed glass vial for 1 hour at 25° C., affording a 7 wt % polyamic acid solution. A mixture of mesoporous silicate particles in DMAc dispersion and a DMAc solution of polyamic acid was stirred vigorously at 25° C. for 5 hours. The resulting solution was cast onto a flat glass substrate. The film was placed in an oven for 2 hours at 80° C. to evaporate the DMAc. Then, the polyamic acid composite film was heated at 300° C. for 2 hours, yielding a ˜0.05-mm thick polyimide composite film.

The FR ratings for the composite films in comparison to the pristine polymer were determined using the Underwriter Laboratory ultrathin film procedure UL94VTM. The results presented in the table below show that the UL94 rating of the films is improved from a value of V-1 to the superior value of V-0, as shown in the following Table 3.

TABLE 3

| FR Agent | Loading (pph) | UL 94 Rating |
|---|---|---|
| None | 0.00 | V-1 |
| SAP-90 (CAN #90) | 5 | V-0 |
| | 10 | V-0 |
| MSU-H | 5 | V-0 |
| | 10 | V-0 |

In examples 1-8, the composites utilizing mesoporous silicate particles alone and synergistically in combination with known FR agents exhibit substantial improvements in both PHRR and time to PHRR not only vis-à-vis the pristine polymer specimen, but also the samples employing only synergists, clearly demonstrating the benefit of mesoporous parties.

Of great interest regarding the reduction of PHRR in Examples 1-8 is the formation of high integrity char. As evidenced by the cone calorimeter data as well as the observations during horizontal and vertical burn testing, the composites containing mesoporous silicate particles exhibited solid, coherent char formation, much more than the composites containing synergists alone. Another qualitative element regarding flame retardation is the ability to inhibit dripping. Dripping of flaming molten polymer is most responsible for the spread of fire. The ability of the composites containing mesoporous silicate particles to inhibit dripping of flaming polymer is another important benefit of the present invention.

While certain representative embodiments and details have been shown for purposes of illustrating the invention, it will be apparent to those skilled in the art that various changes may be made without departing from the scope of the disclosure, which is further described in the following appended claims.

We claim:

1. A polymer composition comprising:
a polymer; and
an effective amount of a flame retardant additive, the flame retardant additive comprising a mesoporous silicate.

2. The polymer composition of claim 1 wherein, during combustion of the polymer composition, an improved coherent char is formed when compared to combustion of a polymer composition comprising the polymer without the flame retardant additive.

3. The polymer composition of claim 1 having a property selected from the group consisting of a lower peak heat release rate, a longer time to peak heat release rate, and both a lower peak heat release rate and a longer time to peak heat release rate when compared to a polymer composition comprising the polymer without the flame retardant additive.

4. The polymer composition of claim 1 wherein the polymer is selected from the group consisting of a thermoplastic polymer, a thermoset polymer, an elastomeric polymer, and combinations thereof.

5. The polymer composition of claim 4 wherein the thermoplastic polymer is selected from the group consisting of at least one of acrylonitrile-butadiene-styrene, cellulosic polymers, ethylene vinyl alcohol, ethylene vinyl acetate, liquid crystal polymer, phenolics, polyacetal, polyacrylates, polyacrylonitrile, polyamide, polyamide-imide, polyarylene ether, polyarylene ether-polyamide blends, polyaryletherketone, polybutadiene, polybutylene, polycarbonate, polycholoroprene, polyester and unsaturated polyester, polyetheretherketone, polyetherimide, polyethylene, polyimide, polyphenylene oxide, polyphthalamide, polypropylene, polypropylene and polyethylene copolymers, polystyrene, polyurethane, polyvinylchloride, polyvinylidene chloride, and thermoplastic elastomers.

6. The polymer composition of claim 4 wherein the thermoset polymer is selected from the group consisting of at least one of allyl resin, epoxy, melamine formaldehyde, phenol-formaldehyde plastic, polyester, polyimide, polyurethane, silicone, and silicone rubber.

7. The polymer composition of claim 4 wherein the elastomeric polymer is selected from the group consisting of at least one of ethylene vinyl acetate, styrenic block copolymers, polyolefin blends, elastomeric alloys, thermoplastic polyurethanes, thermoplastic copolyester, and thermoplastic polyamides.

8. A cable or wire coating formed from a polymer composition according to claim 1.

9. A molded or extruded material coated with a polymer composition according to claim 1.

10. A method of promoting char formation comprising the step of burning the polymer composition according to claim 1.

11. A method of forming a polymer composition, comprising: combining a polymer and a flame retardant additive, wherein the flame retardant additive comprises a mesoporous silicate.

12. The method of claim 11 wherein during combustion of the polymer composition an improved coherent char is formed when compared to combustion of a polymer composition comprising the polymer without the flame retardant additive.

13. The method of claim 11 wherein the polymer composition has a property selected from the group consisting of a lower peak heat release rate, a higher time to peak heat release rate, and both a lower peak heat release rate and a longer time to peak heat release rate when compared to a polymer composition comprising the polymer without the flame retardant additive.

14. The method of claim 11 wherein the polymer is selected from the group consisting of a thermoplastic polymer, a thermoset polymer, an elastomeric polymer, and combinations thereof.

15. The method of claim 14 wherein the thermoplastic polymer is selected from the group consisting of at least one of acrylonitrile-butadiene-styrene, cellulosic polymers, ethylene vinyl alcohol, ethylene vinyl acetate, liquid crystal polymer, phenolics, polyacetal, polyacrylates, polyacrylonitrile, polyamide, polyamide-imide, polyarylene ether, polyarylene ether-polyamide blends, polyaryletherketone, polybutadiene, polybutylene, polycarbonate, polycholoroprene, polyester and unsaturated polyester, polyetheretherketone, polyetherimide, polyethylene, polyimide, polyphenylene oxide, polyphthalamide, polypropylene, polypropylene and polyethylene copolymers, polystyrene, polyurethane, polyvinylchloride, polyvinylidene chloride, and thermoplastic elastomers.

16. The method of claim 14 wherein the thermoset polymer is selected from the group consisting of at least one of allyl resin, epoxy, melamine formaldehyde, phenol-formaldehyde plastic, polyester, polyimide, polyurethane, silicone, and silicone rubber.

17. The method of claim 14 wherein the elastomeric polymer is selected from the group consisting of at least one of ethylene vinyl acetate, styrenic block copolymers, polyolefin blends, elastomeric alloys, thermoplastic polyurethanes, thermoplastic copolyester, and thermoplastic polyamides.

18. A polymer composition comprising:
a polymer; and
a flame retardant additive combination comprising a mesoporous silicate and a second filler, wherein the second filler is selected from the group consisting of a second flame retardant additive, an inert filler and combinations thereof.

19. The polymer composition of claim 18 wherein during combustion of the polymer composition an improved coherent char is formed when compared to combustion of a polymer composition comprising the polymer without the flame retardant additive.

20. The polymer composition of claim 18 having a property selected from the group consisting of a lower peak heat release rate, a longer time to peak heat release rate, and both a lower peak heat release rate and a longer time to peak heat release rate when compared to a polymer composition comprising the polymer without the flame retardant additive.

21. The polymer composition of claim 18 wherein the polymer is selected from the group consisting of a thermoplastic polymer, a thermoset polymer, an elastomeric polymer, and combinations thereof.

22. The polymer composition of claim 21 wherein the thermoplastic polymer is selected from the group consisting of at least one of acrylonitrile-butadiene-styrene, cellulosic polymers, ethylene vinyl alcohol, ethylene vinyl acetate, liquid crystal polymer, phenolics, polyacetal, polyacrylates, polyacrylonitrile, polyamide, polyamide-imide, polyarylene ether, polyarylene ether-polyamide blends, polyaryletherketone, polybutadiene, polybutylene, polycarbonate, polycholoroprene, polyester and unsaturated polyester, polyetheretherketone, polyetherimide, polyethylene, polyimide, polyphenylene oxide, polyphthalamide, polypropylene, polypropylene and polyethylene copolymers, polystyrene, polyurethane, polyvinylchloride, polyvinylidene chloride, and thermoplastic elastomers.

23. The polymer composition of claim 21 wherein the thermoset polymer is selected from the group consisting of at least one of allyl resin, epoxy, melamine formaldehyde, phenol-formaldehyde plastic, polyester, polyimide, polyurethane, silicone, and silicone rubber.

24. The polymer composition of claim 21 wherein the elastomeric polymer is selected from the group consisting of at least one of ethylene vinyl acetate, styrenic block copolymers, polyolefin blends, elastomeric alloys, thermoplastic polyurethanes, thermoplastic copolyester, and thermoplastic polyamides.

25. The polymer composition of claim 18 wherein the second flame retardant additive is selected from the group consisting of at least one of aluminum hydroxide, aluminum trihydroxide, gibbsite, bauxite, magnesium carbonate, magnesium oxide, magnesium hydroxide, brucite, hydromagnesite, hunite, hydrotalcite and like mixed magnesium-aluminum hydroxides with layered lattice structures, bentonite, montmorillonite, hectorite, and halloysite nano-clays, boehnite, phosphates, borates, stannates, hydroxystannates, zinc oxide, zinc sulfides, molybdates, ammonium polyphosphates, melamine, melamine phosphates, potassium carbonate, organophosphates, antimony oxide, red phosphorus, brominated hydrocarbons, and combinations thereof.

26. The polymer composition according to claim 18 wherein the inert filler is selected from the group consisting of at least one of chalk, talc, glass powder, and combinations thereof.

27. The polymer composition of claim 18 wherein the proportion of the mesoporous silicate to the second filler is from about 90:10 to about 10:90 by percent weight.

28. The polymer composition of claim 18 wherein the total filler content is from about 1.0% to about 80% by weight.

29. A cable or wire coating formed from a polymer composition according to claim 18.

30. A molded or extruded material coated with a polymer composition according to claim 18.

31. A method of promoting char formation comprising the step of burning the polymer composition according to claim 18.

32. A method of preparing a polymer composition, comprising: combining a polymer and an effective amount of a flame retardant additive combination, wherein the flame retardant additive combination comprises a mesoporous silicate and a second filler, wherein the second filler is selected from the group consisting of a second flame retardant additive, an inert filler and combinations thereof.

33. The method of claim 32 wherein during combustion of the polymer composition an improved coherent char is formed when compared to a polymer composition comprising the polymer without the flame retardant additive.

34. The method of claim 32 wherein the polymer composition has a property selected from the group consisting of a lower peak heat release rate, a longer time to peak heat release rate, and both a lower peak heat release rate and a longer time to peak heat release rate when compared to a polymer composition comprising the polymer without the flame retardant additive.

35. The method of claim 32 wherein the polymer is selected from the group consisting of a thermoplastic polymer, a thermoset polymer, an elastomeric polymer, and combinations thereof.

36. The method of claim 35 wherein the thermoplastic polymer is selected from the group consisting of at least one of acrylonitrile-butadiene-styrene, cellulosic polymers, ethylene vinyl alcohol, ethylene vinyl acetate, liquid crystal polymer, phenolics, polyacetal, polyacrylates, polyacrylonitrile, polyamide, polyamide-imide, polyarylene ether, polyarylene ether-polyamide blends, polyaryletherketone, polybutadiene, polybutylene, polycarbonate, polycholoroprene, polyester and unsaturated polyester, polyetheretherketone, polyetherimide, polyethylene, polyimide, polyphenylene oxide, polyphthalamide, polypropylene, polypropylene and polyethylene copolymers, polystyrene, polyurethane, polyvinylchloride, polyvinylidene chloride, and thermoplastic elastomers.

37. The method of claim 35 wherein the thermoset polymer is selected from the group consisting of at least one of allyl resin, epoxy, melamine formaldehyde, phenol-formaldehyde plastic, polyester, polyimide, polyurethane, silicone, and silicone rubber.

38. The method of claim 35 wherein the elastomeric polymer is selected from the group consisting of at least one of ethylene vinyl acetate, styrenic block copolymers, polyolefin blends, elastomeric alloys, thermoplastic polyurethanes, thermoplastic copolyester, and thermoplastic polyamides.

39. The method of claim 32 wherein the second flame retardant additive is selected from the group consisting of at least one of aluminum hydroxide, aluminum trihydroxide, gibbsite, bauxite, magnesium carbonate, magnesium oxide, magnesium hydroxide, brucite, hydromagnesite, hunite, hydrotalcite and like mixed magnesium-aluminum hydroxides with layered lattice structures, bentonite, montmorillonite, hectorite, and halloysite nano-clays, boehnite, phosphates, borates, stannates, hydroxystannates, zinc oxide, zinc sulfides, molybdates, ammonium polyphosphates, melamine, melamine phosphates, potassium carbonate, organophosphates, antimony oxide, red phosphorus, brominated hydrocarbons, and combinations thereof.

40. The method of claim 32 wherein the inert filler is selected from the group consisting of at least one of chalk, talc, glass powder, and combinations thereof.
